(19) United States
(12) Patent Application Publication
(10) Pub. No.: US 2022/0258736 A1
(43) Pub. Date: Aug. 18, 2022

(54) DRIVER ASSISTANCE SYSTEM FOR A MOTOR VEHICLE, AND MOTOR VEHICLE

(71) Applicant: Audi AG, Ingolstadt (DE)

(72) Inventor: Reimund LIMBACHER, Ingolstadt (DE)

(73) Assignee: Audi AG, Ingolstadt (DE)

(21) Appl. No.: 17/610,381

(22) PCT Filed: May 11, 2020
(86) PCT No.: PCT/EP2020/063011

§ 371 Date: Jan. 18, 2022

(30) Foreign Application Priority Data
May 13, 2019 (DE) 10 2019 206 897.9

(51) Int. Cl. B60W 30/16; B60W 50/14

(52) U.S. Cl. CPC B60W 30/162; B60W 50/14; B60W 2554/802; B60W 2554/804; B60W 2554/4041; B60W 2050/146; B60W 2552/05; B60W 2540/21; B60W 2420/54; B60W 2540/12; B60W 2540/10; B60W 2540/215

(57) ABSTRACT

The application relates to a driver assistance system for a motor vehicle, comprising a distance measuring system for determining the distance from a preceding vehicle, or an interface by means of which, when properly installed in the motor vehicle, such a distance measuring system of the motor vehicle is signal-connected. The driver assistance system for the motor vehicle includes a controller, configured to keep the motor vehicle at a specified target vehicle speed in an automatic mode and to not allow a distance from the preceding vehicle to fall below a specified target distance The controller is further configured to set a new situation-specific target distance on the basis of at least one ambient parameter detected by sensors. The controller is additionally configured to adopt a new user-specific target distance in response to an input from a vehicle occupant, and to identify a current driving situation and an end of the current driving situation, and to adopt the new target distance solely for the duration of the current driving situation when driving behind another vehicle.

### TECHNICAL FIELD

The application relates to a driver assistance system for a motor vehicle. The application further relates to a motor vehicle having such a driver assistance system.

### BACKGROUND

In this case and in the following, the term “driver assistance system” summarizes various systems of a vehicle that are used to support the driver of a motor vehicle. A well-known system is what is known as a cruise control system which, by means of a corresponding controller, is designed to keep the motor vehicle at a target speed (i.e. a target value) usually set by the driver. A further developed system also uses a distance measuring system, e.g. radar sensors and/or a front camera, in order to identify preceding vehicles that may represent obstacles and, when a specified distance (i.e. a “target distance”) to the preceding vehicle is reached, to reduce the vehicle speed (in deviation to the target speed) and thus to follow the preceding vehicle. If the preceding vehicle accelerates, the system increases the speed of your own vehicle until your own target speed is reached, if necessary. Further systems are, for example, lane keeping systems and the like.

The object of the application is to further simplify the operation of a driver assistance system for the driver.

This object is achieved according to the application by a driver assistance system with the features in accordance with claim 1. In addition, this object is achieved according to the application by a motor vehicle having the features of claim 10. Advantageous and in part inventive embodiments and developments of the application are set out in the dependent claims and the following description.

### BRIEF DESCRIPTION OF DRAWINGS/FIGURES

FIG. 1 shows a schematic side view of a motor vehicle having a driver assistance system.

### DETAILED DESCRIPTION

The driver assistance system according to the application is designed and provided (or installed when properly used in a motor vehicle) for use in a (in particular land-based) motor vehicle (for example a passenger car). The driver assistance system has a distance measuring system for determining a distance from a preceding vehicle or is signal-connected by means of an assigned interface to such a distance measuring system of the motor vehicle when properly installed in the motor vehicle. The driver assistance system also has a controller which is designed to hold the motor vehicle at a specified target vehicle speed in an automatic mode. This means that the controller is designed in particular to regulate the vehicle speed of the motor vehicle to the target value. In the automatic mode (in particular when driving behind another vehicle), the controller is also designed not to allow a distance from the preceding vehicle to fall below a specified target distance, i.e. to regulate the distance between the motor vehicle and the preceding vehicle to the target distance, provided that the target value of the vehicle speed is greater than the value of the vehicle speed of the vehicle driving in front (also referred to as “distance control”). In addition, the controller is designed—in the automatic mode—to adapt the target distance in a situation-specific manner on the basis of ambient parameters recorded by sensors (i.e. by means of corresponding sensors), specifically to set a new target distance. The controller is additionally designed to adopt a new user-specific target distance in response to an input from a vehicle occupant. In addition, the controller is designed to identify a current driving situation and an end of the current driving situation and to adopt the new (at least the user-specific) target distance as the new target value solely for the duration of the current driving situation (i.e. temporarily) when driving behind another vehicle.

The controller is preferably designed to automatically adapt the target distance to different driving situations, which can be derived from the above-mentioned ambient parameter, for example from a detected traffic density, restricted visibility (e.g. due to fog, precipitation, light conditions), road surface conditions (e.g. smoothness of the road surface, road damage or the like). For this purpose, the controller preferably evaluates different sensors, for example external light sensors, radar sensors, cameras, or the like. This procedure can also be summarized under the term predictive cruise control.

When the end of the current driving situation is detected, the controller is preferably also designed to adopt the “old” target distance that was valid before the change to the new target distance as the current target distance.

When properly installed, the controller is furthermore preferably connected to a drive system of the motor vehicle or designed as part of a control processor of the motor vehicle.

The expression “when driving behind another vehicle” is understood here and in the following in particular to mean that the motor vehicle is kept at the target distance behind a preceding vehicle (in particular in a quasi-stationary state) using the controller.

The only temporary adaptation of the target distance advantageously allows a vehicle occupant, in particular the driver, to adapt the target distance to the situation in a particularly simple manner, in particular without having to reverse the adaptation later. In particular, the driver can also make changes to the target distance that are only valid for a relatively short period of time (in particular in relation to the entire duration of the journey or at least the duration of the journey on the same road).

The driver assistance system described above is preferably used not only in a predictive cruise control but also in an (at least partially) autonomous driving mode serving at least for motorway driving or also in a (completely) autonomous driving mode.

The controller is preferably also designed to monitor a time interval from the preceding vehicle as the distance. This distance is often referred to as a “time gap” or the like. As a user-independent basic setting, a distance value of 1.8 seconds is specified, for example, which corresponds to a spatial distance according to the rule of thumb “half the speedometer”—regardless of the current value of the vehicle speed.

The motor vehicle according to the application, which is in particular land-based, has the driver assistance system described further above and below. The motor vehicle thus has the features and advantages described in the context of the driver assistance system in equal measure.

In a preferred embodiment, the controller is designed to identify the end of the current driving situation on the basis of at least one criterion selected from a change in road type (e.g. change from country road to motorway or the like), loss (i.e. there is no longer any preceding vehicle in the range of the target distance) or change of the preceding vehicle, change of a possible (permitted or given due to external circumstances) vehicle speed range (e.g. entering or leaving a construction site region on a motorway, change of the curviness of the route, change from free travel to convoy, traffic jam or “stop and go,” change of road surface and/or visibility), end of a phone call, end of the driving cycle (e.g. switching off the ignition or the engine), and/or registration of another vehicle driver (i.e. driver, e.g. on the basis of a key identification number).

The driver assistance system preferably has at least one input converter which is signal-connected to the controller. The controller is designed to adopt (“set”) the new target distance upon actuation of the input converter by the driver. The actuation of the input converter by the driver therefore represents at least one form of the driver's input mentioned above.

In an expedient embodiment of the invention, the input converter is a microphone which is used to pick up a voice command from the driver and is thus arranged in the motor vehicle in particular in the region of the driver's seat, preferably in the head region of the driver. In this case, the controller is preferably designed to only use an output signal from the microphone as an actuation of the microphone to adopt the new target distance when, in particular, a corresponding voice command is identified on the basis of the output signal. In other words, the controller performs speech recognition and only interprets a registered sound input as an actuation if a voice command correspondingly stored or identified by means of machine learning algorithms (e.g. “Drive closer,” “Keep more distance” or the like) is detected. For example, the controller is also designed to carry out an adaptation, in the case of comparatively unspecific commands such as “Keep more distance” (here: an increase), of the temporal distance to the next “round” tenth value (for example from 1.8 seconds to 1.9) or by 0.1 seconds, 0.25 seconds or the like.

In an additional embodiment of the invention, the input converter is a switch or a button for manual actuation by the driver. For example, this switch or this button is properly installed on a (multifunction) steering wheel, in its vicinity, e.g. in the form of a steering column lever, in the region of a gear selector lever, in a, in particular, touch-sensitive screen or the like.

The controller is preferably designed to terminate the automatic mode upon actuation of a brake (in particular the brake pedal) of the motor vehicle by the driver. However, this termination of the automatic mode does not necessarily result in the end of the driving situation; rather, if the automatic mode is resumed within a specified period of time, the previous driving situation (e.g. a drive within a motorway construction site, an ongoing phone call, etc.) can still be present such that the user-specific, new target distance continues to be temporarily set as the target distance.

In an exemplary embodiment of the invention, however, the controller is designed to maintain the automatic mode upon actuation of the brake by the driver when driving behind another vehicle, in particular at least for a specified period of time, provided that the braking force applied and/or the deceleration caused due to the actuation of the brake (in particular a temporal gradient of the deceleration or a negative acceleration) does not exceed a specified threshold value. The controller is therefore designed in particular to identify (optionally with additional use of the distance measuring system) on the basis of the actuation of the brake whether only an adaptation of the target value is desired or—in extreme cases—emergency braking (e.g. during an evasive maneuver, approaching the end of a traffic jam etc.) is carried out. Excessive braking (at which the aforementioned threshold value is exceeded) preferably results in the controller switching off the automatic mode. Since the automatic mode is generally not terminated immediately the driver, upon actuation of the brake, the driver advantageously has a simple possibility of specifying, in particular, a greater distance value as the new target distance. For many drivers, braking is the simplest and, from a subjective point of view, easily understandable possibility of adapting the distance (and also the vehicle speed) to a value that is perceived as suitable for the current driving situation.

In an optionally additional variant of the above monitoring of the braking force or deceleration, the controller is designed in particular to use the fact that the brake remains actuated as an additional condition, in particular in the case of a correspondingly low braking force. The controller therefore checks whether a kind of “dragging” of the brake takes place with a sufficiently low braking force and in this case maintains the automatic mode, preferably at least for the specified period of time.

In addition or as an alternative to this dragging, the controller is designed to refrain from accelerating to the previous target value of the vehicle speed or from approaching the preceding vehicle up to the target distance, in particular during the specified period of time despite the automatic mode still being activated. In other words, in this case, “tapping” the brake (in particular below the braking force threshold value) results in a temporary suspension (but not a complete deactivation) of the distance control and/or the speed control.

In a further exemplary embodiment of the invention, the controller is designed to allow a distance to fall below the target distance upon acceleration by the vehicle occupant when driving behind another vehicle (in particular in a quasi-stationary manner). In other words, in this case, the controller allows the driver to “force” the vehicle to fall below the target distance by the actuation of the accelerator pedal.

In an exemplary expedient of the invention, both in the event that the automatic mode is not switched off when driving behind another vehicle despite actuation of the brake, and in the event that the driver allows the distance to forcibly fall below the target distance—the controller is designed to adopt the current distance value as the new target distance when the actuation of the brake is no longer carried out, when the acceleration is no longer carried out by the vehicle occupant, or when the actuation of the accelerator pedal is no longer carried out by the driver. In other words, the driver can set a new target distance by lightly braking or accelerating (and subsequently going “off the brakes” or “off the accelerator”). In this case, the controller identifies that the distance value resulting from the driver's behavior (in particular at the end of braking or the end of the active “closer” approach) is desired by the driver as the new target distance. This makes the operation of the driver assistance system more intuitive, hardly perceived as an active change for the driver, and thus simplified.

In another embodiment of the invention, the controller—both in the event that the automatic mode is not switched off when driving behind another vehicle despite actuation of the brake, and in the event that the driver allows the distance to forcibly fall below the target distance—is designed to adopt the current distance value as the new target distance upon actuation of the input converter. As a result, the driver can, for example, briefly “tap” the brake, let the motor vehicle roll to the new desired distance, and, for example, use the voice command “Keep this distance” to specify it as a new temporary target distance. Correspondingly, a reduction in the target distance is possible by actively approaching the preceding vehicle from the driver's side. As an alternative to the voice command, the driver can also actuate the switch or the button. In this case, the controller is designed to interpret, in particular, only a “simple” actuation of the switch or the button as an actuation for adopting the current distance value as the new target distance. In particular, the controller is designed to reject a long key press (for example longer than 1.5 seconds), a multiple press (in particular in the manner of a double click), and/or a combination of different switches or buttons. As a result, in particular when using the brake to adapt the target speed, the driver does not need to memorize any “higher value” (in the sense of complex) operating steps for the input of the new target value. The change in the target distance of the vehicle speed thus becomes more intuitive.

If, in particular during the actuation of the brake, the actuation of the input converter is not carried out until the specified period of time has elapsed, the controller is preferably designed to terminate the automatic mode.

A further operating element, for example a switch, a button, a type of rocker switch, lever, or the like, by means of which the driver can change the target distance temporarily as an alternative to the brake and accelerator pedals, is also optionally provided. For example, the controller is designed to use a simple actuation of this additional operating element for a specified jump (for example by 0.15 to 0.3, in particular 0.25 seconds) to a higher or lower target distance (corresponding, for example, to an actuation direction of the lever). Alternatively, the controller is designed to use the value of the time distance that is present at the end of an actuation of this further operating element that lasts for a longer period of time (for example greater than 0.5 seconds) as the new user-specific target distance. In particular, the controller continuously accelerates or decelerates the motor vehicle during the actuation of the further operating element.

The distance measuring system is preferably a camera (in particular looking in the direction of travel), a radar sensor, or a combination thereof. The distance measuring system is used, among other things, to identify not only vehicles but also obstacles in the route ahead. In this case, the controller is also designed in particular to deviate from the current target value of the vehicle speed in order to avoid a collision with the identified obstacle or the vehicle, preferably to reduce the vehicle speed as part of the distance control.

In a preferred embodiment, the controller is designed to display the new target distance at the start of the automatic mode and/or in the automatic mode when the target distance is changed, i.e. when the new target distance is automatically set as well as in the event of a user-specific change, solely for a specified period of time, in particular solely for 2 to 6 seconds, preferably solely for about 3 seconds.

In a further expedient embodiment of the invention, the controller is designed to use, in particular in the automatic mode (and in particular when the vehicle is not driving behind another vehicle), an input by the driver, which is made by means of the input converter or optionally by means of a further input converter—in particular a further switch or a further button, in order to permanently change the target distance. In this way, the driver can therefore specify a target distance, from which the temporary adaptation described above takes place, if necessary.

Optionally, the permanent adaptation of the target distance described above is also relocated to a setting menu of the vehicle controller. For example, a permanent adaptation made in this way can also be assigned to a vehicle key assigned to a specific driver.

The conjunction “and/or” is to be understood in this case and in the following in particular in such a way that the features linked by means of this conjunction can be designed both together and as alternatives to one another.

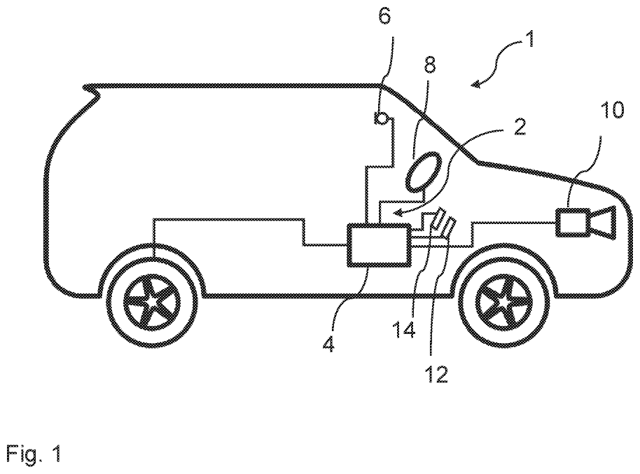

An embodiment of the invention is explained in more detail below with reference to a drawing. The single FIG. 1 shows, in a schematic side view, a motor vehicle having a driver assistance system.

In FIG. 1, a motor vehicle 1 is shown. This motor vehicle comprises a driver assistance system 2. The driver assistance system 2 has a controller 4 which is designed to regulate the vehicle speed of the motor vehicle 1 to a target value in an automatic mode. The driver assistance system 2 has at least one, in the present embodiment specifically two, input converters, which are signal-connected to the controller 4. These input converters are an (interior) microphone 6 and a button (not shown in detail) arranged on a multifunction steering wheel 8. The controller 4 is also designed to use sensor data transmitted by a distance measuring system, in this case a radar system 10, which is directed forward in the direction of travel, to regulate a distance from a slower preceding vehicle to a specified target distance (when driving behind another vehicle).

The controller 4 is additionally designed to adopt a new target distance upon actuation of the microphone 6 or the button on the multifunction steering wheel 8. To this end, the controller 4 carries out speech recognition and only evaluates a speech input as a corresponding actuation if, for example, the command “Drive closer,” “Increase the distance” (or similar) is identified. During the actuation of the button, the controller 4 sets the current distance (i.e. the current distance value) as the new, user-specific target distance.

For example, while the motor vehicle 1 is being guided by the controller 4 behind a vehicle, i.e. the so-called distance control is active (i.e. when driving behind another vehicle), the driver of the motor vehicle 1 can press the accelerator pedal 12 until he has reached his desired distance value and then actuate the button on the multifunction steering wheel 8.

The driver can also give the voice command “keep more distance” or “keep less distance,” whereupon the controller 4 increases or decreases the previous target distance by 0.1 seconds and sets the resulting value as a new, user-specific target distance.

In addition, the controller 4 is designed to terminate the automatic mode upon actuation of a brake (i.e. the brake pedal 14) of the motor vehicle 1. In addition, however, the controller 4 is designed to maintain the automatic mode upon actuation of the brake pedal 14 by the driver when driving behind another vehicle for a specified period of time (e.g. for 5 to 10 seconds), provided that the braking force applied due to the actuation of the brake does not exceed a specified threshold value. The controller 4 therefore checks whether there is only slight braking, which is only used to adapt the current speed. For example, a self-learning algorithm is implemented in the controller 4 for this purpose. Optionally, the threshold value is specified depending on the actual value of the vehicle speed. In the event of excessive braking, in which the braking force exceeds the threshold value, the controller 4 switches off the automatic mode.

If the driver then actuates the button or issues a corresponding voice command after such a “slight” actuation of the brake, the controller 4 sets the current distance value as the new target distance.

As an actuation of the button, the controller 4 preferably only interprets a “simple” actuation (in particular a short actuation lasting less than 0.5 seconds). The controller 4 rejects other actuations of the button.

If the actuation of the microphone 6 or the button is not carried out until the specified period of time has elapsed, the controller 4 is designed to terminate the automatic mode.

The controller 4 is additionally designed to only adopt this change in the target distance initiated by the driver when driving temporarily behind another vehicle, specifically solely for the current driving situation. The controller 4 is designed to identify a current driving situation—for example when driving behind another vehicle in a motorway construction site—and the end of the driving situation. In the present example, the controller 4 identifies the end of the driving situation from the fact that the vehicle leaves motorway construction site. In this case, the controller 4 changes back to the previous target distance.

The motor vehicle 1 also comprises a display device (not shown in detail), for example a conventional instrument panel or a screen on which driving information such as the current actual value of the vehicle speed and the like can be displayed. The controller 4 is designed to display the target value—when starting the automatic mode or when adapting the target value—solely for a specified period of time of about 3 seconds.

The subject matter of the application is not limited to the embodiment described above. Rather, further embodiments of the application can be derived from the above description by a person skilled in the art.

1.-10. (canceled)

11. A driver assistance system for a motor vehicle, comprising:
a distance measuring system for determining a distance from a preceding vehicle;
an interface configured for signal-connection of the distance measuring system, the interface further configured to support installation of the distance measuring system in the motor vehicle; and
a controller configured to:
keep the motor vehicle at a specified target vehicle speed in an automatic mode,
disallow the distance from the preceding vehicle to fall below a specified target distance,
set a new situation-specific target distance based on at least one ambient parameter detected by sensors,
adopt a new user-specific target distance in the automatic mode in response to an input from an occupant of the motor vehicle,
identify a current driving situation and an end of the current driving situation, and
adopt the new user-specific target distance for a duration of the current driving situation, the duration being while driving behind the preceding vehicle.

12. A driver assistance system according to claim 11, wherein the controller is further configured to identify the end of the current driving situation based on at least one criterion selected from a change in a type of road, a loss of the preceding vehicle, a change in a possible vehicle speed range, an end of a phone call, an end of a driving cycle, or registration of another vehicle driver.

13. A driver assistance system according to claim 11, further comprising:
an input converter which is signal-connected to the controller,
wherein the controller is further configured to adopt the new target distance upon actuation of the input converter by the occupant,
wherein the input converter includes a microphone for receiving a voice command from the occupant,
wherein the controller is further configured to use an actuation of the microphone to adopt the new user-specific target distance when the voice command is identified, and
wherein the input converter further includes a switch or a button for manual actuation by the occupant.

14. A driver assistance system according to claim 11, wherein the controller is further configured to:
terminate the automatic mode upon actuation of a brake of the motor vehicle by the occupant; and
switch to the automatic mode upon actuation of the brake when driving behind another vehicle for a specified period of time, provided that a braking force applied or a deceleration caused due to the actuation of the brake does not exceed a specified threshold value.

15. A driver assistance system according to claim 11, wherein the controller is further configured to allow the distance to fall below the target distance upon acceleration by the vehicle occupant when driving behind another vehicle.

16. A driver assistance system according to claim 14, wherein the controller is further configured to adopt a current distance value as the new target distance when the actuation of the brake is discontinued, when acceleration is discontinued by the occupant, or when the actuation of an accelerator pedal of the motor vehicle is discontinued by the occupant.

17. A driver assistance system according to claim 13, wherein the controller is further configured to adopt the current distance value as the new target distance upon actuation of the input converter.

18. A driver assistance system according to claim 11, wherein the controller is further configured to display the target distance at a start of the automatic mode or a change in the target distance in the automatic mode for a specified period of time.

19. A driver assistance system according to claim 11, wherein the controller is further configured to use an input made by the occupant using the input converter or another input converter in order to permanently change the target distance.

20. A motor vehicle comprising:
a driver assistance system comprising:
a distance measuring system for determining a distance from a preceding vehicle;
an interface configured for signal-connection of the distance measuring system, the interface further configured to support installation of the distance measuring system in the motor vehicle; and
a controller configured to:
keep the motor vehicle at a specified target vehicle speed in an automatic mode,
disallow the distance from the preceding vehicle to fall below a specified target distance,
set a new situation-specific target distance based on at least one ambient parameter detected by sensors,
adopt a new user-specific target distance in the automatic mode in response to an input from an occupant of the motor vehicle,
identify a current driving situation and an end of the current driving situation, and
adopt the new user-specific target distance for a duration of the current driving situation, the duration being while driving behind the preceding vehicle.
